(19) United States
(12) Patent Application Publication
(10) Pub. No.: US 2010/0283769 A1
(43) Pub. Date: Nov. 11, 2010

(54) ORGANIC LIGHT EMITTING DISPLAY DEVICE AND DRIVING METHOD THEREOF

(75) Inventor: Wook LEE, Yongin-city (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung Mobile Display Co., Ltd., Yongin-city (KR)

(21) Appl. No.: 12/711,021

(22) Filed: Feb. 23, 2010

(30) Foreign Application Priority Data
May 6, 2009 (KR) 10-2009-0039205

(51) Int. Cl. G09G 5/00; G09G 3/30

(52) U.S. Cl. 345/204; 345/76

(57) ABSTRACT

An organic light emitting display is disclosed. In one aspect, the display includes a controller configured to receive an input image signal asynchronous with the first clock, to generate an output image signal based on the input image signal, and to supply the output image signal to the scan and data drivers, wherein the output image signal is synchronous with the first clock. As a result, the image brightness is not dependent upon the frequency of the input image signal.

### CROSS-REFERENCE TO RELATED APPLICATIONS

This application claims priority to and the benefit of Korean Patent Application No. 10-2009-0039205, filed on May 6, 2009, in the Korean Intellectual Property Office, the entire content of which is incorporated herein by reference.

### BACKGROUND

1. Field

The field relates to an organic light emitting display device and a driving method thereof, and more particularly, to an organic light emitting display device, which can allow brightness to be maintained constant although a control signal is changed, and a driving method of the organic light emitting display device.

2. Description of the Related Technology

Various types of flat panel display devices having reduced weight and volume as compared with cathode ray tubes have been developed. The flat panel display devices include a liquid crystal display device, a field emission display device, a plasma display panel, an organic light emitting display device, and the like.

Among the flat panel display devices, the organic light emitting display device has various advantageous characteristics, such as having excellent color reproduction, and being thin. Accordingly, its application fields have been widely extended to markets of mobile phones, PDAs, MP3 players and the like.

An organic light emitting display device displays images using organic light emitting diodes (OLEDs) in which luminance of light is determined corresponding to an amount of current input to each of the OLEDs.

In general, a flat panel display device displays an image corresponding to a frame in response to a scan signal, a data signal, a vertical synchronization signal, a horizontal synchronization signal, a clock, and one or more other input signals. The signals input to the flat panel display device may be transmitted according to one of a PAL system, an NTSC system, and the like. One difference between the various systems is system frequency.

Where difference of frequencies occurs, the periods of a horizontal synchronization signal, a vertical synchronization signal, a clock and the like are different. The vertical synchronization signal is a signal that allows one frame to be distinguished from the next frame. As the period of the vertical synchronization signal is shortened, the periods of the horizontal synchronization signal, the clock, and the like are also shortened. As the period of the vertical synchronization signal is lengthened, the periods of the horizontal synchronization signal, the clock and the like are likewise lengthened.

For this reason, the time when a pixel emits light is frequency dependent. Therefore, the amount of current that flows during one frame is frequency dependent, and the luminance of an organic light emitting display device is also frequency dependent.

Accordingly, the organic light emitting display device is not used for general purpose applications of varying frequency due to these dependencies.

### SUMMARY OF CERTAIN INVENTIVE ASPECTS

One aspect is an organic light emitting display device. The display device includes a pixel unit configured to display an image in response to scan and data signals, a data driver configured to generate the data signal and to supply the generated data signal to the pixel unit, a scan driver configured to generate the scan signal and to supply the generated scan signal to the pixel unit, an oscillator for generating a first clock, and a controller configured to receive an input image signal asynchronous with the first clock, to generate an output image signal based on the input image signal, and to supply the output image signal to the scan and data drivers, where the output image signal is synchronous with the first clock.

Another aspect is a driving method of an organic light emitting display device having a pixel unit, a data driver and a scan driver. The method includes receiving an input image signal, generating a first clock with an oscillator, generating an output image signal based on the input image signal, and supplying the output image signal to the data and scan drivers, where the output image signal is synchronous with the first clock.

Another aspect is an organic light emitting display device, including means for displaying an image, means for supplying data signals to the displaying means, means for supplying scan signals to the displaying means, means for receiving an input image signal, means for generating a first clock with an oscillator, means for generating an output image signal based on the input image signal, and means for supplying the output image signal to the data and scan signal supplying means, where the output image signal is synchronous with the first clock.

### BRIEF DESCRIPTION OF THE DRAWINGS

The accompanying drawings, together with the specification, illustrate exemplary embodiments, and, together with the description, serve to explain various inventive principles.

FIG. 1 is a block diagram illustrating an organic light emitting display device according to one embodiment.

FIG. 2 is a block diagram illustrating a data driver employed in the organic light emitting display device according to one embodiment.

FIG. 3 is a block diagram illustrating a scan driver employed in the organic light emitting display device according to one embodiment.

### DETAILED DESCRIPTION OF CERTAIN INVENTIVE EMBODIMENTS

Hereinafter, certain exemplary embodiments will be described with reference to the accompanying drawings. Here, when a first element is described as being coupled to a second element, the first element may be not only directly coupled to the second element but may be indirectly coupled to the second element via a third element. Further, some of the elements that are not essential to the complete understanding of the invention are omitted for clarity. Also, like reference numerals generally refer to like elements throughout.

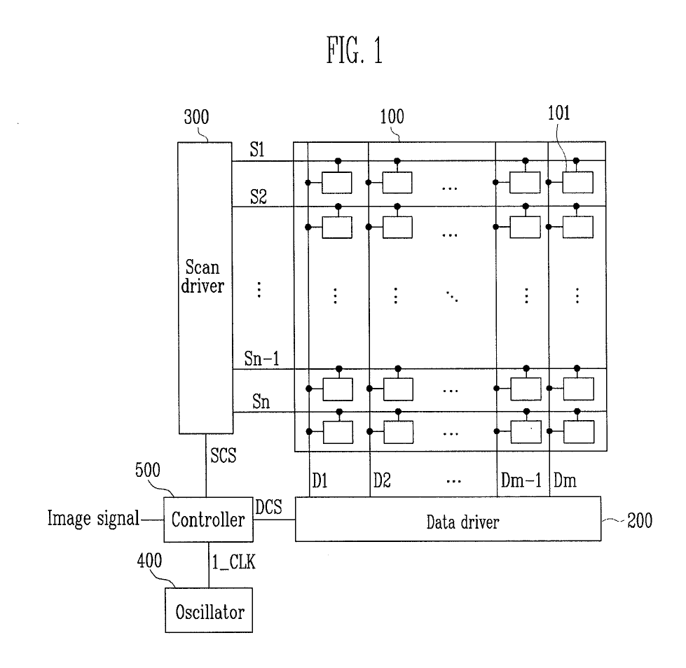

FIG. 1 is a block diagram illustrating the structure of an organic light emitting display device according to one embodiment.

Referring to FIG. 1, the organic light emitting display device includes a pixel unit 100, a data driver 200, a scan driver 300, an oscillator 400 and a controller 500.

A plurality of pixels 101 are arranged in the pixel unit 100. Each of the pixels includes an organic light emitting diode (not shown). The pixel unit 100 has n scan lines S1, S2, . . . , Sn-1 and Sn and m data lines D1, D2, . . . , Dm-1 and Dm, arranged therein. Here, scan signals are transmitted in a row direction through the n scan lines S1, S2, Sn-1 and Sn, and data signals are transmitted in a column direction through the m data lines D1, D2, . . . , Dm-1 and Dm.

The pixel unit 100 is driven with a first power source (not shown) and a second power source (not shown). The first power source has a lower voltage level than that of the second power source. In the pixel unit 100, current flows into the organic light emitting diodes according to the scan signals, data signals, the first power source and the second power source. The pixel unit 100 emits light according to light emitted by the light emitting diodes. Accordingly, the pixel unit 100 displays an image.

The data driver 200 is a means for generating data signals. The data driver 200 generates data signals based on image signals including an RGB video signal with red, green and blue components, a vertical synchronization signal, a horizontal synchronization signal and the like. The data driver 200 is coupled to the data lines D1, D2, . . . , Dm-1 and Dm of the pixel unit 100 to apply the generated data signals to the pixel unit 100.

The scan driver 300 is a means for generating scan signals. The scan driver 300 is coupled to the scan lines S1, S2, . . . , Sn-1 and Sn to supply scan signals to specific rows of the pixel unit 100. The data signal output from the data driver 200 is supplied to a pixel 101 receiving a scan signal supplied from the scan driver 300, and a voltage corresponding to the data signal is applied to the pixel 101.

The oscillator 400 is a means for generating a first clock 1_CLK. The oscillator 400 generates a first clock 1_CLK with a substantially constant period. In some embodiments, the first clock 1_CLK is asynchronous with the image signal input from the outside. A vertical synchronization signal, a horizontal signal, a second clock, a start pulse and the like, are synchronized according to the first clock 1_CLK.

The controller 500 controls the operation of the data driver 200 by supplying a data driving control signal DCS, an RGB video signal, and the like. The controller 500 controls the operation of the scan driver 300 by supplying a scan driving control signal SCS, an RGB video signal, and the like. The data driving control signal DCS refers to a vertical synchronization signal, a horizontal signal, a second clock, a start pulse and the like. The scan driving control signal SCS refers to a vertical synchronization signal, a horizontal signal, a second clock, a start pulse, and the like.

The controller 500 receives a vertical synchronization, a horizontal synchronization, a second clock, a start pulse, an image signal and the like. In some embodiments, the received signals are PAL system signals. In some embodiments, the received signals are NTSC system signals. Other system signals may also be used. The controller 500 determines the period of a signal, such as a vertical synchronization, a horizontal synchronization, a second clock or a start pulse, using a first clock generated from the oscillator 400. In some embodiments, the first clock is a PAL system clock. In some embodiments, the first clock is an NTSC system clock.

In some embodiments, the oscillator 400 is formed together with the data driver 200 and the controller 500 in the same chip.

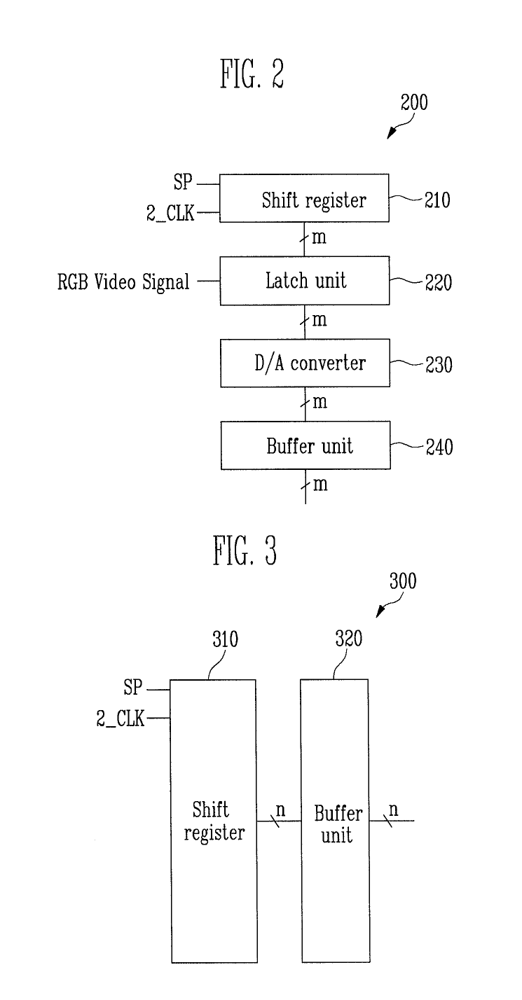

FIG. 2 is a block diagram illustrating an embodiment of a data driver employed in the organic light emitting display device according to some embodiments.

Referring to FIG. 2, the data driver 200 includes a shift register 210, a latch unit 220, a digital/analog (D/A) converter 230 and a buffer unit 320.

The shift register 210 receives a start pulse SP and a second clock 2_CLK and outputs a shift signal. The time when the shift signal is output from the shift register 210 is based on the second clock 2_CLK.

The latch unit 220 allows video signals input in series to be output in parallel in response to the vertical and horizontal synchronization signals from the controller 500. The latch unit 220 receives a shift signal and a second clock 2_CLK from shift register 210. A video signal Video Signal input to a first terminal of the latch unit 220 is supplied to a next terminal of the latch unit 220 in response to the shift signal, and a new video signal Video Signal is supplied to the first output terminal of the latch unit 220. Video signals supplied to one row of the pixel unit 100 through the aforementioned procedure are supplied to the latch unit 220 and are then output at the same time. Accordingly, the video signals input in series are output in parallel.

The D/A converter 230 converts a video signal Video Signal into an analog signal. Here, the video signal Video Signal is a digital signal.

The buffer unit 240 allows the analog signal outputted from the D/A converter 230 to be output as a buffered data signal.

In the data driver 200 configured as described above, the start pulse SP, the video signal Video Signal, the second clock 2_CLK and, in some embodiments, other signals are synchronized with the first clock 1_CLK from the oscillator 400. That is, the timing of the start pulse SP, the video signal Video Signal, and the second clock 2_CLK are determined based on the first clock 1_CLK from the oscillator 400. The operation of the data driver 200 is determined by the signals synchronized with the first clock 1_CLK. If the timing of the start pulse SP, the video signal Video Signal, and the second clock 2_CLK are changed by a change in frequency of the image signal, the duration for which a data signal is supplied to each of the pixels is also changed. As a result, the data signal may not be correctly supplied to each of the pixels 101. Consequently, the luminance of the pixels may depend on the frequency. However, according to various embodiments, the start pulse SP, the vertical and horizontal synchronization signals, the second clock 2_CLK and the like are synchronized by the first clock 1_CLK from the oscillator 400, so that the timing of the start pulse SP, the video signal Video Signal, and the second clock 2_CLK is maintained constant regardless of the frequency of the image signal input from the outside. Accordingly, the luminance of the pixels is not changed.

FIG. 3 is a block diagram illustrating an embodiment of a scan driver employed in the organic light emitting display device according to some embodiments.

Referring to FIG. 3, the scan driver 300 includes a shift register 310 and a buffer unit 320.

The shift register 310 receives a start pulse SP and a second clock 2_CLK, corresponding to a vertical synchronization, and outputs a shift signal. A first output terminal of the shift register 310 outputs a first shift signal in response to the start pulse SP and the second clock 2_CLK. The first shift signal is supplied to a second terminal of the shift register 310 and the buffer unit 320. A second output terminal of the shift register 310 outputs a second shift signal in response to the first shift signal and the second clock 2_CLK. The second shift signal is supplied to a third terminal of the shift register 310 and the buffer unit 320. By repeating the aforementioned procedure, the shift register 310 sequentially outputs the first to last shift signals. The shift signal outputted to the buffer unit 320 corresponds to a scan signal.

The buffer unit 320 outputs the first to last scan signals to be supplied to the respective scan lines.

In the scan driver 300 configured as described above, the vertical synchronization signal and the second clock 2_CLK are synchronized by the first clock 1_CLK from the oscillator 400. That is, the periods of the vertical synchronization signal and the second clock 2_CLK are determined by the first clock 1_CLK from the oscillator 400. If the periods of the vertical synchronization signal and the second clock 2_CLK are changed, the time corresponding to one frame is changed. Accordingly, the time when a scan signal is supplied to each of the pixels is also changed. Therefore, the luminance of the pixels may be changed depending on frequencies.

However, the vertical synchronization signal and the second clock 2_CLK are synchronized by the first clock 1_CLK outputted from the oscillator 400, so that the periods of the vertical synchronization signal and the second clock 2_CLK are substantially constant regardless of the frequency of the image signal input from the outside. Accordingly, the luminance of the pixels is not changed.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An organic light emitting display device, comprising:
a pixel unit configured to display an image in response to scan and data signals;
a data driver configured to generate the data signal and to supply the generated data signal to the pixel unit;
a scan driver configured to generate the scan signal and to supply the generated scan signal to the pixel unit;
an oscillator for generating a first clock; and
a controller configured to receive an input image signal asynchronous with the first clock, to generate an output image signal based on the input image signal, and to supply the output image signal to the scan and data drivers, wherein the output image signal is synchronous with the first clock.

2. The organic light emitting display device according to claim 1, wherein the frequency of the output image signal is determined by the first clock.

3. The organic light emitting display device according to claim 1, wherein the data driver, the oscillator and the controller are formed in one chip.

4. The organic light emitting display device according to claim 1, wherein the output image signal includes a vertical synchronization signal, a horizontal synchronization signal, a start pulse, a video signal, and a second clock.

5. The organic light emitting display device according to claim 1, wherein the input image signal is a PAL system signal.

6. The organic light emitting display device according to claim 5, wherein the first clock is an NTSC system clock.

7. The organic light emitting display device according to claim 1, wherein the input image signal is an NTSC system signal.

8. The organic light emitting display device according to claim 7, wherein the first clock is a PAL system clock.

9. A driving method of an organic light emitting display device having a pixel unit, a data driver and a scan driver, the method comprising:
receiving an input image signal;
generating a first clock with an oscillator;
generating an output image signal based on the input image signal; and
supplying the output image signal to the data and scan drivers, wherein the output image signal is synchronous with the first clock.

10. The driving method according to claim 9, wherein the output image signal includes a vertical synchronization signal, a horizontal synchronization signal, an RGB video signal, and a second clock.

11. The driving method according to claim 9, wherein the oscillator and the data driver are formed in one chip.

12. The driving method according to claim 9, further comprising determining the frequency of the output image signal based on the first clock.

13. The driving method according to claim 9, wherein the input image signal is a PAL system signal.

14. The driving method according to claim 13, wherein the first clock is an NTSC system clock.

15. The driving method according to claim 9, wherein the input image signal is an NTSC system signal.

16. The driving method according to claim 15, wherein the first clock is a PAL system clock.

17. An organic light emitting display device, comprising:
means for displaying an image;
means for supplying data signals to the displaying means;
means for supplying scan signals to the displaying means;
means for receiving an input image signal;
means for generating a first clock with an oscillator;
means for generating an output image signal based on the input image signal; and
means for supplying the output image signal to the data and scan signal supplying means, wherein the output image signal is synchronous with the first clock.

18. The organic light emitting display device according to claim 17, wherein the oscillator and the data supplying means are formed in one chip.

19. The organic light emitting display device according to claim 17, wherein the input image signal is a PAL system signal and the first clock is an NTSC system clock.

20. The organic light emitting display device according to claim 17, wherein the input image signal is an NTSC system signal and the first clock is a PAL system clock.
